(19) United States
(12) Patent Application Publication
(10) Pub. No.: US 2006/0273738 A1
(43) Pub. Date: Dec. 7, 2006

(54) Cold cathode fluorescent lamp

(76) Inventor: Barrie James Holst, New South Wales (AU)

Correspondence Address: ABELMAN, FRAYNE & SCHWAB, 666 THIRD AVENUE, 10TH FLOOR, NEW YORK, NY, 10017, US

(21) Appl. No.: 11/368,136

(22) Filed: Mar. 2, 2006

(30) Foreign Application Priority Data
Jun. 6, 2005 (AU) 2005902931

(51) Int. Cl. H05B 41/36

(52) U.S. Cl. 315/224

(57) ABSTRACT

An elongated cold cathode fluorescent lamp (10) consists of an elongated extruded polycarbonate cover or diffuser (11), an elongated lamp tube (12) adapted to be connected to an electric supply located within and spaced from the cover or diffuser (11) by at least a pair of O rings (13). The cover or diffuser (11) is formed from a clear polycarbonate which has been pre-mixed with a translucent white colour before extrusion.

This invention relates to cold cathode fluorescent lamps and more particularly to cold cathode fluorescent lamps specifically designed to illuminate planar screens such as the display screens of electronic gaming machines, poker machines, slot machines and the like.

Cold cathode fluorescent lamps are usually supplied as elongated lamps or circular lamps, each of which has a specific application of use with inherent limitations as to the intensity of light for a specific area.

There is a need, however, for a cold cathode fluorescent lamp which achieves the required distribution with maximum transmission of the available light.

There is also a need for a cold cathode fluorescent lamp which can operate at increased temperatures and which possesses high impact strength.

According to one aspect of the invention there is provided a elongated cold cathode fluorescent lamp comprising an elongated extruded tubular polycarbonate cover or diffuser, an elongated lamp tube adapted to be connected to an electric supply located within and spaced from the cover or diffuser, and, at least a pair of “O” rings locating the lamp tube within the cover or diffuser.

Preferably, the cover or diffuser is formed from a clear polycarbonate which has been pre-mixed with a translucent white colour before extrusion. The dry colour mix achieves the required distribution with maximum transmission of the available light.

According to another aspect of the invention there is provided an electrical circuit for a plurality of elongated cold cathode fluorescent lamps, said circuit including at least a first inverter a second inverter and a third inverter, the first inverter having a first connector adapted to be connected to a D.C. power supply and a second connector, the second inverter having a first connector coupled to the second connector of the first converter and a second connector adapted to be coupled to the first connector of a third inverter, each inverter having at least one receptacle for a cold cathode fluorescent lamp and wherein each inverter is electrically configured to provide the operating strike voltage for a pre-determined length of cold cathode fluorescent lamp.

In order that the invention may be more readily understood and put into practical effect, reference will now be made to the accompanying drawings in which:

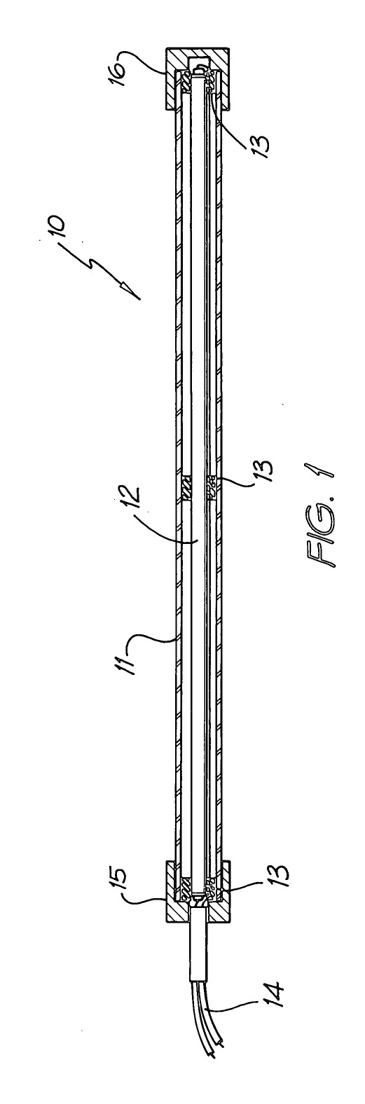

FIG. 1 is a cross-sectional view of a cold cathode fluorescent lamp according to one embodiment of the invention, and

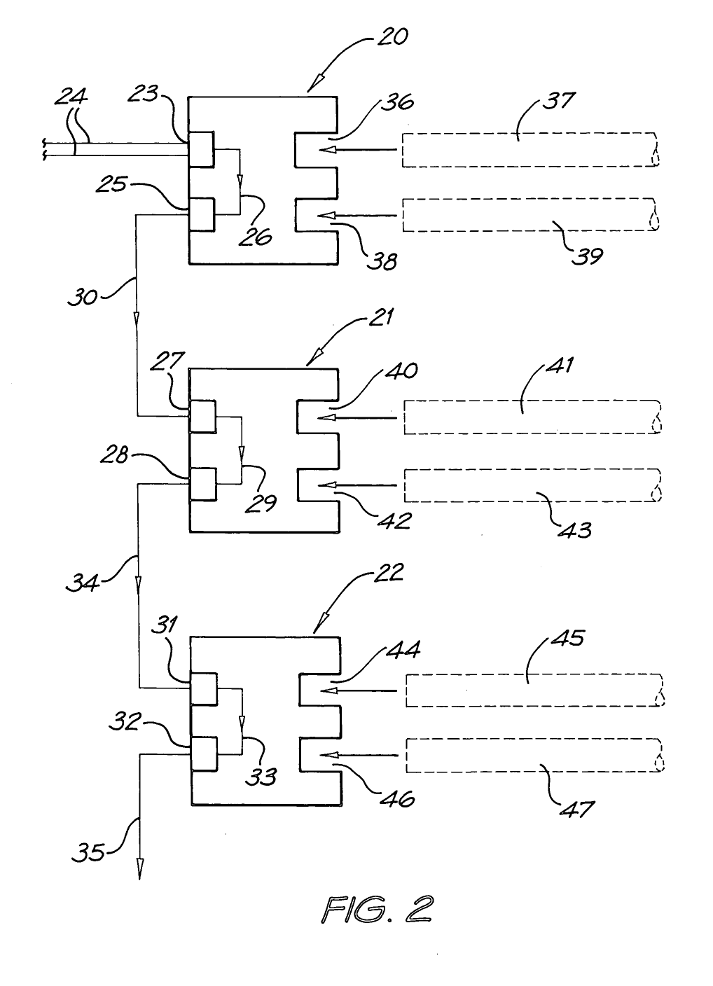

FIG. 2 is a schematic diagram of an electrical circuit for powering an array of cold cathode fluorescent lamps.

The cold cathode fluorescent lamp 10 shown in FIG. 1 includes an outer tubular cover or diffuser 11, and an inner lamp tube 12 which is spaced from the outer diffuser 11 by a plurality of “O” rings 13. At the end of the lamp 10 there is a first mounting block 15 and at the other end of the lamp 10 there is a second mounting block 16. The fluorescent lamp 10 is connected to an appropriate voltage supply through an inverter by electrical connections 14 which project through the first mounting block 15 and which are connected to the ends of the lamp tube 12.

The cover or diffuser tube 11 is extruded from polycarbonate to increase its operating temperature and impact strength compared with the usual materials of acrylic or ABS. Prior to extrusion, a translucent white colour is mixed with the clear polycarbonate to provide a dry colour mix which achieves the required even distribution with maximum transmission of the available light.

The fragile glass lamp tube 12 is centrally located within the outer polycarbonate tube 11 by clear extruded silicone “O” rings 13 which are situated at 100 mm spacings. Silicone “O” rings are preferred because of their higher operating temperature capability.

The cold cathode fluorescent lamp 10 may be of any convenient length, say 100 mm, 200 mm, 300 mm and 400 mm. The external diameter of the lamp may be 11 mm and the internal diameter 8 mm.

The electrical circuit shown in FIG. 2 includes, in this instance, three inverters 20, 21 and 22. The first inverter 20 has a first connector 23 which is connected to the 12 volt or 24 volt D.C. supply of a gaming machine by a pair of conductors 24. Beneath the first connector 23 there is a second connector 25 that is electrically connected to the first connector 23 by conductors 26.

The second inverter 21 has a first connector 27 and a second connector 28 which are electrically connected by conductor 29. The first connector 27 is electrically connected to the second connector 25 of the first inverter 20 by electrical conductors 30.

Similarly, the third inverter 22 has a first connector 31 and a second connector 32 which are electrically connected to each other by conductors 33. The first connector 31 is electrically connected to the second connector 28 of the second inverter 21 by electrical conductors 34. The second conductor 32 is adapted to be connected to a further inverter by electrical conductors 35.

In this instance, each inverter 20, 21 and 22 is adapted to run a pair of cold cathode fluorescent lamps as shown in dotted outline in FIG. 2. The first inverter 20 has a first lamp receptacle 36 adapted to receive a first lamp 37 and a second lamp receptacle 38 adapted to receive a second lamp 39. The receptacles 36 and 38 are electrically connected to the input connector 23 by conductors not shown.

The second inverter 21 has a first lamp receptacle 40 adapted to receive a first lamp 41 and a second receptacle 42 adapted to receive a second lamp 43. The receptacles 40 and 42 are electrically connected to the input connector 27 by conductors not shown.

The third inverter 22 has a first lamp receptacle 44 adapted to receive a first lamp 45 and a second receptacle 46 adapted to receive a second lamp 47. The receptacles 44 and 46 are electrically connected to the input connector 31 by conductors not shown.

Each inverter 20, 21 and 22 is electrically configured to power identical lamps. Thus, inverter 20 may be electrically configured to power to 100 mm long lamps, inverter 21 may be electrically configured to power to 200 mm long lamps and inverter 22 may be electrically configured to power to 400 mm long lamps. Separate electrical configuration is required for each length of lamp so that the inverter may deliver the appropriate strike voltage for the given length of lamp.

1. An elongated cold cathode fluorescent lamp comprising an elongated extruded polycarbonate cover or diffuser, an elongated lamp tube adapted to be connected to an electric supply located within and spaced from the cover or diffuser, and, at least a pair of O rings locating the lamp tube within the cover or diffuser.

2. An elongated cold cathode fluorescent lamp according to claim 1 wherein the cover or diffuser is formed from a clear polycarbonate which has been pre-mixed with a translucent white colour before extrusion.

3. An electrical circuit for a plurality of elongated cold cathode fluorescent lamps, said circuit including at least a first inverter, a second inverter, and a third inverter the first inverter having a first connector adapted to be connected to a D.C. power supply and a second connector, the second inverter having a first connector coupled to the second connector of the first converter and a second connector adapted to be coupled to the first connector of the third inverter, each inverter having at least one receptacle for a cold cathode fluorescent lamp and wherein each inverter is electrically configured to provide the operating strike voltage for a pre-determined length of cold cathode fluorescent lamp.

4. An electric circuit according to claim 3 wherein each inverter has two receptacles for receiving similar cold cathode fluorescent lamps.
